(19) United States
(12) Patent Application Publication
(10) Pub. No.: US 2026/0004471 A1
(43) Pub. Date: Jan. 1, 2026

(54) MODEL UPDATE METHOD, IMAGE GENERATION METHOD, DEVICE, AND MEDIUM

(71) Applicant: Beijing Zitiao Network Technology Co., Ltd., Beijing (CN)

(72) Inventor: Li CHEN, Beijing (CN)

(21) Appl. No.: 19/252,305

(22) Filed: Jun. 27, 2025

(30) Foreign Application Priority Data
Jun. 28, 2024 (CN) 202410867210.4

(51) Int. Cl. G06T 11/00

(52) U.S. Cl. CPC G06T 11/00; G06T 2211/441

(57) ABSTRACT

A model update method, an image generation method, a device and a medium are provided. The method includes: acquiring sample text, a noisy image and a first noise distribution; using a second model to process the sample text and the noisy image to obtain a second noise distribution, where an initial value of the second model is determined based on the first model; and updating the second model based on the second noise distribution, the first noise distribution, and the target noise distribution, such that a difference between the target noise distribution and a third noise distribution predicted by the updated second model is greater than a difference between the second noise distribution and the target noise distribution, and a difference between the third noise distribution and the first noise distribution does not exceed a difference between the target noise distribution and the first noise distribution.

### CROSS-REFERENCE TO RELATED APPLICATION

The present application claims priority of the Chinese Patent Application No. 202410867210.4, filed on Jun. 28, 2024, the disclosure of which is incorporated herein by reference in its entirety as part of the present application.

### TECHNICAL FIELD

The present disclosure relates to a model update method, an image generation method, a device, and a medium.

### BACKGROUND

In some scenarios, a diffusion model can be used to perform a text-to-image generation task. The diffusion model includes a text encoder and a denoising network. The working principle of the diffusion model is as follows: firstly, the text encoder is used to encode user-input text, such as “a photo of a person”, to obtain a text feature; and then the denoising network is used to process the text feature and noise to obtain a generated image.

However, some diffusion models have defects and may generate some images that are not good, such as low-quality images or images with unsafe content, resulting in a poor image generation effect.

### SUMMARY

The present disclosure provides a model update method. The method includes: acquiring sample text, a noisy image corresponding to the sample text, and a first noise distribution corresponding to the sample text, where the noisy image is obtained by adding noise to a sample image corresponding to the sample text according to a target noise distribution, the sample image does not meet a preset constraint, and the first noise distribution is predicted by a first model based on the sample text; using a second model to process the sample text and the noisy image to obtain a second noise distribution, where an initial value of the second model is determined based on the first model; and updating the second model based on the second noise distribution, the first noise distribution, and the target noise distribution, to obtain an updated second model, where a difference between the target noise distribution and a third noise distribution predicted by the updated second model based on the sample text is greater than a difference between the second noise distribution and the target noise distribution; and a difference between the third noise distribution and the first noise distribution does not exceed a difference between the target noise distribution and the first noise distribution.

In a possible implementation, the updating the second model based on the second noise distribution, the first noise distribution and the target noise distribution, includes: calculating the difference between the first noise distribution and the target noise distribution to obtain a first difference, and calculating the difference between the second noise distribution and the target noise distribution to obtain a second difference; determining a model loss of the second model based on the first difference, a weight corresponding to the first difference, the second difference, and a weight corresponding to the second difference, where the weight corresponding to the first difference is a positive number, and the weight corresponding to the second difference is a negative number; and updating the second model based on the model loss.

In a possible implementation, the first model is obtained by using an image that meets the preset constraint and text corresponding to the image that meets the preset constraint to perform model training.

In a possible implementation, the target noise distribution includes a noise ground-truth corresponding to each timestep in a timestep sequence; the first noise distribution includes a first noise prediction value corresponding to each timestep in the timestep sequence; and the second noise distribution includes a second noise prediction value corresponding to each timestep in the timestep sequence.

The present disclosure provides an image generation method. The method includes: acquiring text to be processed; and using a diffusion model to process the text to be processed to obtain a generated image, where the diffusion model is obtained using the model update method according to the present disclosure, and the generated image meets the preset constraint.

The present disclosure provides a model update apparatus. The model update apparatus includes a first acquiring unit, a first processing unit and a model update unit.

The first acquiring unit is configured to acquire sample text, a noisy image corresponding to the sample text and a first noise distribution corresponding to the sample text, where the noisy image is obtained by adding noise to a sample image corresponding to the sample text according to a target noise distribution, the sample image does not meet a preset constraint, and the first noise distribution is predicted by a first model based on the sample text.

The first processing unit is configured to use a second model to process the sample text and the noisy image to obtain a second noise distribution, where an initial value of the second model is determined based on the first model.

The model update unit is configured to update the second model based on the second noise distribution, the first noise distribution and the target noise distribution, to obtain an updated second model, where a difference between the target noise distribution and a third noise distribution predicted by the updated second model based on the sample text is greater than a difference between the second noise distribution and the target noise distribution; and a difference between the third noise distribution and the first noise distribution does not exceed a difference between the target noise distribution and the first noise distribution.

The present disclosure provides an image generation apparatus. The image generation apparatus includes a second acquiring unit and a second processing unit.

The second acquiring unit is configured to acquire text to be processed.

The second processing unit is configured to use a diffusion model to process the text to be processed to obtain a generated image, where the diffusion model is obtained using the model update method according to the present disclosure, and the generated image meets the preset constraint.

The present disclosure provides an electronic device. The electronic device includes a processor and a memory, where the memory is configured to store instructions or a computer program; and the processor is configured to execute the instructions or the computer program in the memory, to cause the electronic device to perform the model update method or the image generation method according to the present disclosure.

The present disclosure provides a computer-readable medium, and the computer-readable medium stores instructions or a computer program. When the instructions or the computer program is run on a device, the device is caused to perform the model update method or the image generation method according to the present disclosure.

The present disclosure provides a computer program product, which includes a computer program carried on a non-transitory computer-readable medium, where the computer program includes program code used for performing the model update method or the image generation method according to the present disclosure.

### BRIEF DESCRIPTION OF DRAWINGS

In order to more clearly describe the technical solutions in the embodiments of the present disclosure or in the related art, the drawings for describing the embodiments or the related art will be briefly described below. Apparently, the drawings in the description below show merely some embodiments recited in the present disclosure, and persons of ordinary skill in the art may still derive other drawings from these drawings without creative efforts.

FIG. 1 is a structural schematic diagram of a diffusion model according to an embodiment of the present disclosure;

FIG. 2 is a flowchart of a model update method according to an embodiment of the present disclosure;

FIG. 3 is a flowchart of an image generation method according to an embodiment of the present disclosure;

FIG. 4 is a structural schematic diagram of a model update apparatus according to an embodiment of the present disclosure;

FIG. 5 is a structural schematic diagram of an image generation apparatus according to an embodiment of the present disclosure; and

FIG. 6 is a structural schematic diagram of an electronic device according to an embodiment of the present disclosure.

### DETAILED DESCRIPTION

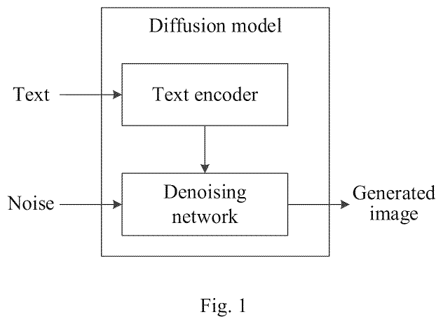

It has been found through research that a diffusion model may be used to perform some image generation tasks, such as a text-to-image generation task. The diffusion model may include at least a denoising network, such as a denoising network shown in FIG. 1. The denoising network is used to generate a new image, such as a generated image shown in FIG. 1, based on text provided by a user. In addition, the denoising network may include at least a noise predictor (such as Unet) and a noise removal module. When the denoising network is used to perform a generation task, the working principle of the denoising network at each timestep is as follows: first, the noise predictor performs noise prediction on a current noisy image to obtain predicted noise; and then the noise removal module removes the predicted noise from the current noisy image to obtain a noise-removed image. It can be learned that a new image can be obtained after the denoising network is used to implement noise removal at all timesteps.

It has also been found through research that in some scenarios, the diffusion model can be trained to learn an image generation capability. The performance of the diffusion model may be affected by the quality of training images used during the training process. Therefore, to better improve the performance, some high-quality images may be selected from a large number of images as training data, with the expectation that the diffusion model trained by using the training data has an improved performance.

It has also been found through research that high-quality images are difficult to obtain, and the quantity of high-quality images is relatively small. As a result, when only the high-quality images are used to train the diffusion model, the learning effect and the image generation performance of the model may be affected due to the small quantity of training data, which makes it possible that the model generates some images that are not good, such as low-quality images or images with unsafe content. When the defect of the small quantity of training data is overcome by adding some low-quality images, the diffusion model may learn from these low-quality images some undesirable features, such as incorrect overall structures and incorrect color schemes, which makes the images generated by using the diffusion model not good, such as having low quality or unsafe content, thereby affecting the image generation performance of the diffusion model.

It has further been found through research that the diffusion model shown in the previous paragraph is only trained to learn how to generate an image, but the generation process of the diffusion model is uncontrollable, which makes it possible that the diffusion model generates both good outputs such as high-quality images or images with safe content, and bad outputs such as low-quality images or images with unsafe content, thus affecting the image generation effect. It can be learned therefrom that the trained diffusion model only has the image generation capability and lacks a feature screening capability, and the diffusion model cannot independently determine whether some features are good or bad, making it possible that the diffusion model sometimes outputs images that are not good, such as low-quality images or images with unsafe content, thus affecting the image generation effect.

Based on the above researches, to better improve the image generation effect, the present disclosure provides a solution. In the solution, for a first model with a good performance in text-to-image generation, such as for a diffusion model that is pre-trained based on high-quality images, the optimization process for the first model includes: first, acquiring sample text, a noisy image corresponding to the sample text, and a first noise distribution corresponding to the sample text, where the noisy image is obtained by adding noise to a sample image corresponding to the sample text according to a target noise distribution, the sample image does not meet a preset constraint, and the first noise distribution is predicted by a first model based on the sample text; next, using a second model to process the sample text and the noisy image, to obtain a second noise distribution, where an initial value of the second model is determined based on the first model; and then, updating the second model based on the second noise distribution, the first noise distribution, and the target noise distribution to obtain an updated second model, the updated second model meets the following constraint, in which a difference between the target noise distribution and a third noise distribution predicted by the updated second model based on the sample text is greater than a difference between the second noise distribution and the target noise distribution, and a difference between the third noise distribution and the first noise distribution does not exceed a difference between the target noise distribution and the first noise distribution, such that the noise distribution predicted by the updated second model is as far as possible from the noise distribution predicted by the second model before the update, and the noise distribution predicted by the updated second model is as close as possible to the noise distribution predicted by the first model. On the premise that the model's original generation capability is maintained as much as possible, it is conducive to enabling the model to learn the content that the model cannot generate, such as the content that does not meet the preset constraint, so as to enable the model to forget the data that does not meet the preset constraint on the premise that the model's original generation capability is maintained as much as possible. Therefore, the model has both an image generation capability and a certain feature screening capability, which can effectively ensure that subsequent images generated by using the model all meet the preset constraint, thereby effectively avoiding defects caused by the generation of images that do not meet the preset constraint, and then improving the image generation effect.

In addition, an execution body of the model update method according to the embodiments of the present disclosure is not limited in the present disclosure. For example, the model update method according to the embodiments of the present disclosure may be applied to a terminal device or a server. For another example, the model update method according to the embodiments of the present disclosure may also be implemented with the aid of a data interaction process between the terminal device and the server. Herein, the terminal device may be a smartphone, a computer, a personal digital assistant (PDA) or a tablet computer. The server may be a stand-alone server, a cluster server, or a cloud server.

In order for persons skilled in the art to better understand the solutions of the present disclosure, the technical solutions in the embodiments of the present disclosure will be described below clearly and completely with reference to the accompanying drawings in the embodiments of the present disclosure. Apparently, the embodiments described are merely some rather than all of the embodiments of the present disclosure. All other embodiments obtained by persons of ordinary skill in the art based on the embodiments of the present disclosure without creative efforts fall within the scope of protection of the present disclosure.

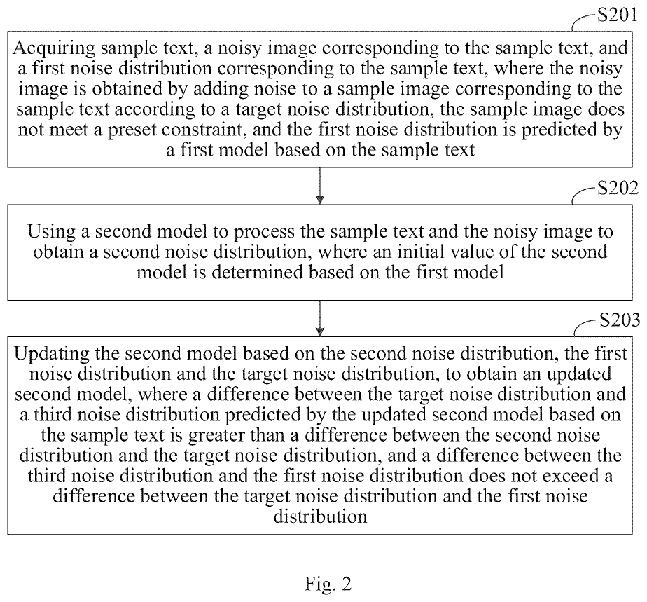

For a better understanding of the technical solutions according to the present disclosure, the model update method according to the present disclosure is first described below in conjunction with some drawings. As shown in FIG. 2, the model update method according to the embodiment of the present disclosure includes S201 to S203 below. FIG. 2 is a flowchart of a model update method according to an embodiment of the present disclosure.

S201: acquiring sample text, a noisy image corresponding to the sample text, and a first noise distribution corresponding to the sample text, where the noisy image is obtained by adding noise to a sample image corresponding to the sample text according to a target noise distribution, the sample image does not meet a preset constraint, and the first noise distribution is predicted by a first model based on the sample text.

The sample text is text, such as “a photo of a person”, that needs to be used in one round of optimization process. In addition, the method for acquiring the sample text is not limited in the present disclosure. For example, the sample text may be first text that is randomly selected from a training text set, such that the first text can represent the text that needs to be used in a stage of performance optimization for a diffusion model with a good image generation performance.

The sample image corresponding to the sample text is an image that needs to be used for training the diffusion model to learn what content it should not generate, such as low-quality images or images with unsafe content, such that the diffusion model subsequently learns the content that it should not generate from the sample image. It should be noted that the method for acquiring the sample image is not limited in the present disclosure.

In addition, for the sample image corresponding to the sample text, the sample image does not meet the preset constraint, such that the sample image is used to represent an image that should not be generated when image generation processing is performed based on the sample text, and the sample image can represent content that should not be generated when image generation processing is performed based on the sample text, such as poor overall image structures, poor distributions of light, and poor distributions of facial features. Therefore, the diffusion model can subsequently learn the content that it should not generate from the sample image, such as content that does not meet the preset constraint. The preset constraint is used to describe an image generation requirement in a practical application scenario, such as a requirement for generating high-quality images or images with safe content, such that the model obtained by using images that do not meet the preset constraint for training can learn that the model cannot generate content that does not satisfy the image generation requirement.

The noisy image corresponding to the sample text is obtained by adding noise to the sample image corresponding to the sample text according to the target noise distribution, such that the noisy image can represent a result of noise addition processing for the sample image, allowing the noisy image to subsequently participate in the image generation process as data that needs to be denoised.

The target noise distribution refers to noise used in a noise addition process, also known as a diffusion process or a forward process, such that the target noise distribution can represent image information carried in the above sample image to a certain degree. The target noise distribution is used to represent a noise ground-truth corresponding to the noisy image, such that the target noise distribution can be used as valuable guidance information in the subsequent training process to ensure that the finally trained diffusion model can learn to no longer fit the target noise distribution. In this way, the diffusion model can forget the image information carried in the sample image.

In addition, an implementation of the target noise distribution is not limited in the present disclosure. For example, the target noise distribution may include a noise ground-truth corresponding to each timestep in a timestep sequence. The timestep sequence is used to record a plurality of sequentially arranged timesteps, and the timestep sequence is not limited in the present disclosure. For example, the timestep sequence may be a sequence of {Step1, Step2, Step3, Step4, . . . , StepT}, where T is a positive integer. The t^{th} timestep is a timestep at the t^{th} arrangement position in the timestep sequence, and a noise ground-truth corresponding to the t^{th} timestep is noise actually added at the t^{th} timestep, where t is a positive integer and t≤T.

Additionally, an implementation of the above noise addition processing is not limited in the present disclosure. For example, the implementation may be achieved by a one-time noise addition method, such as by adding noise ground-truths corresponding to all the timesteps at a time. For another example, the implementation may be achieved by a multi-round iterative method, such as by adding only one noise ground-truth corresponding to one timestep in each round.

The first model is a pre-trained diffusion model that has a good image generation performance, such as a diffusion model that is trained based on some high-quality images. It can be learned that the first model has a good performance in text-to-image generation.

In addition, in a possible implementation, the first model may be trained by using the second text and a label image corresponding to the second text, such that the first model can learn how to generate content described by the label image. The second text is text that is randomly selected from a training text set, such that the second text can represent text that needs to be used in a stage of learning the image generation performance for a diffusion model. The label image corresponding to the second text is an image that should be generated based on the second text, and meets a preset constraint, such that the label image may be an image that needs to be used for training the diffusion model to learn the image generation performance, such as a high-quality image or an image with safe content. It should be noted that the relationship between the second text and the above first text is not limited in the present disclosure. For example, the second text and the above first text may be identical or different.

Based on the content in the previous paragraph, it can be learned that in a possible implementation, the first model may be obtained by using the image that meets the preset constraint and the text corresponding to the image that meets the preset constraint to perform model training, such that the first model can learn the performance in text-to-image generation based on the image that meets the preset constraint and its corresponding text, allowing the image output by the first model to meet the preset constraint as much as possible. The “text corresponding to the image that meets the preset constraint” is text that needs to be used when the image that meets the preset constraint is used for model training, and the “text corresponding to the image that meets the preset constraint” satisfies the following condition: semantic information described by the “text corresponding to the image that meets the preset constraint” is consistent with information described by the image that meets the preset constraint.

In addition, the method for acquiring the above first model is not limited in the present disclosure, and may be implement by using any of the existing or future methods that may train a diffusion model with a good performance in text-to-image generation based on some pieces of text and their corresponding images.

The first noise distribution corresponding to the sample text is a noise prediction result that is obtained by using the first model to process the sample text, such that the first noise distribution can represent the image generation performance of the first model to a certain degree.

It can be learned that in a possible implementation, the process of determining the first noise distribution may be as follows: a noise predictor (such as Unet) in the first model performs noise prediction based on noise to be processed and a text feature of the sample text, to obtain and output the first noise distribution. The noise to be processed is noise data that is input into the noise predictor. An implementation of the noise to be processed is not limited in the present disclosure. For example, the noise to be processed may be randomly generated noise. For another example, the noise to be processed may be the noisy image corresponding to the above sample text. The text feature of the sample text is used to represent information carried in the sample text. The method for acquiring the text feature is not limited in the present disclosure, and may be, for example, implemented using a text encoder in the first model.

Based on the content in the previous paragraph, it can be learned that the first noise distribution corresponding to the sample text is predicted by the first model based on the sample text, for example, is predicted by the noise predictor in the first model based on the text feature of the sample text. Since the first model has a good performance in text-to-image generation, the first noise distribution obtained by using the first model can represent, to a certain degree, a feature that corresponds to the sample text and meets the preset constraint, such that the first noise distribution can be subsequently used as valuable guidance information to ensure that a noise distribution predicted by an optimized model for the sample text is as far as possible from the target noise distribution on the premise that the noise distribution predicted by an optimized model for the sample text is not as far as possible from the first noise distribution. It facilitates forgetting the image that does not meet the preset constraint on the premise that the image generation performance is maintained as much as possible.

It can be learned that in a possible implementation, the above first noise distribution satisfies at least the following condition: a new image obtained after using the first noise distribution to perform denoising processing satisfies the preset constraint, such that the first noise distribution can represent, to a certain degree, a good performance of the first model in text-to-image generation.

In addition, an implementation of the above first noise distribution is not limited in the present disclosure. For example, the first noise distribution may include a first noise prediction value corresponding to each timestep in the timestep sequence. The first noise prediction value corresponding to the t^{th} timestep refers to the noise predicted by the first model and added at the t^{th} timestep, such that the “first noise prediction value corresponding to the t^{th} timestep” can be subsequently used as valuable guidance information to ensure that the noise predicted by the optimized model for the sample text at the t^{th} timestep is as far as possible from the above “noise ground-truth corresponding to the t^{th} timestep” on the premise that the noise predicted by the optimized model for the sample text at the t^{th} timestep is not as far as possible from the “first noise prediction value corresponding to the t^{th} timestep”, where t is a positive integer and t≤T.

S202: using a second model to process the sample text and the noisy image to obtain a second noise distribution, where an initial value of the second model is determined based on the first model.

The second model is a diffusion model that needs to be updated in a current round of optimization process. An implementation of the second model is not limited in the present disclosure. For example, in response to the current round of optimization process being an initial round of optimization process for the first model, the second model may refer to an initial value determined based on the first model, such that a model structure and parameters of the initial value are respectively kept consistent with corresponding content in the first model. In response to the current round of optimization process being a non-initial round of optimization process for the first model, such as an Nth round of optimization process, where N≥2, the second model may be an updated model obtained by performing a previous round of optimization process, such as an (N−1) th round of optimization process.

It can be learned that the relationship between the above second model and the above first model is that the initial value of the second model is determined based on the first model. Based on the relationship, it can be learned that in the first round of optimization process, the second model refers to the initial value determined based on the first model, such that the second model is exactly the same as the first model; in the second round of optimization process, the second model is an updated model obtained after the first round of optimization process is completed; in the third round of optimization process, the second model is an updated model obtained after the first two rounds of optimization process are sequentially completed; . . . (and so on); and in the N^{th} round of optimization process, the second model is an updated model obtained after the first (N−1) rounds of optimization process are sequentially completed, where N is a positive integer.

The second noise distribution is a noise prediction result that is obtained by using the second model to process the sample text, such that the second noise distribution can represent the image generation performance of the second model to a certain degree.

It can be learned that in a possible implementation, the process of determining the second noise distribution may be as follows: a noise predictor (such as Unet) in the second model performs noise prediction processing based on the noisy image corresponding to the sample text and the text feature of the sample text, to obtain and output the second noise distribution.

In addition, an implementation of the above second noise distribution is not limited in the present disclosure. For example, the second noise distribution may include a second noise prediction value corresponding to each timestep in the timestep sequence. The second noise prediction value corresponding to the t^{th} timestep is noise predicted by the second model and added at the t^{th} timestep, such that the “second noise prediction value corresponding to the t^{th} timestep” can represent, to a certain degree, a noise prediction performance of the second model at the t^{th} timestep, where t is a positive integer and t≤T.

S203: updating the second model based on the second noise distribution, the first noise distribution and the target noise distribution, to obtain an updated second model, where a difference between the target noise distribution and a third noise distribution predicted by the updated second model based on the sample text is greater than a difference between the second noise distribution and the target noise distribution, and a difference between the third noise distribution and the first noise distribution does not exceed a difference between the target noise distribution and the first noise distribution.

The updated second model is an updated model that is obtained by performing the current round of optimization process, such that the performance of the updated second model is better than the performance of the second model before the update.

The third noise distribution is a noise prediction result that is obtained by using the updated second model to process the sample text, such that the third noise distribution can represent the image generation performance of the updated second model to a certain degree.

It can be learned that in a possible implementation, the process of determining the third noise distribution may be as follows: a noise predictor (such as Unet) in the updated second model performs noise prediction based on the noisy image corresponding to the sample text and the text feature of the sample text, to obtain and output the third noise distribution.

In addition, the above third noise distribution may at least reach the following state: the difference between the third noise distribution and the target noise distribution is greater than the difference between the second noise distribution and the target noise distribution, such that the third noise distribution is farther from the target noise distribution than the second noise distribution, and thus the forgetting degree of the diffusion model that generates the third noise distribution for the image that does not meet the preset constraint is higher than the forgetting degree of the diffusion model that generates the second noise distribution for the image that does not meet the preset constraint, which facilitates forgetting the image that does not meet the preset constraint.

Additionally, the above third noise distribution may also reach the following state: the difference between the third noise distribution and the first noise distribution does not exceed the difference between the target noise distribution and the first noise distribution, such that the third noise distribution lies between the first noise distribution and the target noise distribution. This is conducive to making the third noise distribution farther from the target noise distribution while the third noise distribution is not far from the first noise distribution as much as possible, so as to ensure that the model optimization direction is being far from the target noise distribution and as close as possible to the first noise distribution, thereby making it possible for the model to forget the data that does not meet the preset constraint on the premise that the model's original generation capability is maintained as much as possible.

It has been found through research that the present disclosure further provides a possible implementation for S203 above, in order to better improve the model performance. In the implementation, S203 may specifically include the following steps 11 to 14.

Step 11: calculating the difference between the first noise distribution and the target noise distribution to obtain a first difference, such that the first difference can represent the difference between the first noise distribution and the target noise distribution.

It should be noted that the method for calculating the above first difference is not limited in the present disclosure, and may be, for example, implemented by using relative entropy, also known as information divergence or KL divergence.

It should also be noted that an implementation of the above first difference is not limited in the present disclosure. For example, when the target noise distribution includes noise ground-truths corresponding to T timesteps and the first noise distribution includes first noise prediction values corresponding to the T timesteps, the first difference may include: a difference between a first noise prediction value corresponding to the 1^{st} timestep and a noise ground-truth corresponding to the 1^{st} timestep, a difference between a first noise prediction value corresponding to the 2^{nd} timestep and a noise ground-truth corresponding to the 2^{nd} timestep, . . . , and a difference between a first noise prediction value corresponding to the T^{th} timestep and a noise ground-truth corresponding to the T^{th} timestep.

Step 12: calculating the difference between the second noise distribution and the target noise distribution to obtain a second difference, such that the second difference can represent the difference between the second noise distribution and the target noise distribution.

It should be noted that the method for calculating the above second difference is not limited in the present disclosure, and may be, for example, implemented by using KL divergence.

It should also be noted that an implementation of the above second difference is not limited in the present disclosure. For example, when the target noise distribution includes noise ground-truths corresponding to T timesteps and the second noise distribution includes second noise prediction values corresponding to the T timesteps, the second difference may include: a difference between a second noise prediction value corresponding to the 1^{st} timestep and a noise ground-truth corresponding to the 1^{st} timestep, a difference between a second noise prediction value corresponding to the 2^{nd} timestep and a noise ground-truth corresponding to the 2^{nd} timestep, . . . , and a difference between a second noise prediction value corresponding to the T^{th} timestep and a noise ground-truth corresponding to the T^{th} timestep.

It should also be noted that a relationship between the execution time of the above step 12 and the execution time of the above step 11 is not limited in the present disclosure. For example, the execution time of the above step 12 is the same as the execution time of the above step 11. For another example, the execution time of the above step 12 is earlier than the execution time of the above step 11. For another example, the execution time of the above step 11 is earlier than the execution time of the above step 12.

Step 13: determining a model loss of the second model based on the first difference, a weight corresponding to the first difference, the second difference and a weight corresponding to the second difference, where the weight corresponding to the first difference is a positive number, and the weight corresponding to the second difference is a negative number.

The weight corresponding to the first difference is used to represent an effect degree of the first difference on the model loss of the second model, and the weight corresponding to the first difference is the positive number. In addition, an implementation of the weight corresponding to the first difference is not limited in the present disclosure. For example, the weight corresponding to the first difference may be 1.

The weight corresponding to the second difference is used to represent an effect degree of the second difference on the model loss of the second model, and the weight corresponding to the second difference is the negative number. In addition, an implementation of the weight corresponding to the second difference is not limited in the present disclosure. For example, the weight corresponding to the second difference may be −1.

The model loss of the second model is used to represent the performance of the second model.

In addition, an implementation of the above step 13 is not limited in the present disclosure, and may be, for example, implemented by using the following formula (1).

$$L = {\sum }_{t = 1}^{T} {𝔼}_{q ( {x}_{t} \vert {x}_{0} )} [ - {D}_{k l} ( q ( {x}_{t} \vert {x}_{t - 1} , {x}_{0} ) ‖ {p}_{θ} ( {x}_{t - 1} \vert {x}_{t} , c ) ) + {D}_{k l} ( q ( {x}_{t} \vert {x}_{t - 1} , {x}_{0} ) ‖ {p}_{ϕ} ( {x}_{t - 1} \vert {x}_{t} , c ) ] \qquad ( 1 )$$

In the formula (1), L represents the model loss of the second model; E represents an expectation; Dₖₗ( ) represents a KL divergence calculation function; q(xₜ|xₜ₋₁, x₀) represents the noise ground-truth corresponding to the t^{th} timestep, p_{θ}(xₜ₋₁|xₜ, c) represents the second noise prediction value corresponding to the t^{th} timestep, p_{θ} represents the second model, θ represents a parameter in the second model, x₀ represents a noisy image corresponding to sample text, xₜ represents data that needs to be denoised at the t^{th} timestep, xₜ₋₁ represents a result of denoising at the t^{th} timestep and may be used subsequently as data that needs to be denoised at an (t−1)^{th} timestep, and c represents the sample text; and p_{ϕ}(xₜ₋₁|xₜ, c) represents the first noise prediction value corresponding to the t^{th} timestep, p_{ϕ} represents the first model, ϕ represents a parameter in the first model, and T represents the quantity of timesteps in the timestep sequence.

It should be noted that the above formula (1) is derived through extensive formulas based on the principle of “maintaining the original generation capability of the diffusion model while making the diffusion model forget the image that does not meet the preset constraint”, such that the optimization process implemented by using the formula (1) can achieve the effect described by the principle.

Step 14: updating the second model based on the model loss.

It should be noted that an implementation of the above step 14 is not limited in the present disclosure. For example, in some scenarios, the step 14 may specifically be: updating the noise predictor in the second model based on the model loss.

It can be learned that in a possible implementation, for the current round of optimization process, after the model loss is obtained, parameters of modules other than the noise predictor in the second model may be fixed, and parameters of the noise predictor in the second model are updated by using the model loss, such that the updated noise predictor has a better performance, and then the diffusion model including the updated noise predictor has a better performance.

Based on the relevant content of the above steps 11 to 14, it can be learned that for some scenarios, after the second noise distribution, the first noise distribution and the target noise distribution are obtained, the model loss of the second model may be calculated by using a preset loss function and the three distributions, such that the model loss can represent the performance of the second model, and the second model can be subsequently updated based on the model loss. Therefore, the updated second model has a better performance.

Based on the relevant content of S201 to S203 above, it can be learned that for the first model with a good performance in text-to-image generation, an optimization process for the first model includes: first, acquiring sample text, a noisy image corresponding to the sample text, and a first noise distribution corresponding to the sample text, where the noisy image is obtained by adding noise to a sample image corresponding to the sample text according to a target noise distribution, the sample image does not meet a preset constraint, and the first noise distribution is predicted by a first model based on the sample text; next, using a second model to process the sample text and the noisy image to obtain a second noise distribution, where an initial value of the second model is determined based on the first model; and then, updating the second model based on the second noise distribution, the first noise distribution and the target noise distribution to obtain an updated second model that meets the following constraint, in which a difference between the target noise distribution and a third noise distribution predicted by the updated second model based on the sample text is greater than a difference between the second noise distribution and the target noise distribution, and a difference between the third noise distribution and the first noise distribution does not exceed a difference between the target noise distribution and the first noise distribution, such that the noise distribution predicted by the updated second model is as far as possible from the noise distribution predicted by the second model before the update, and the noise distribution predicted by the updated second model is as close as possible to the noise distribution predicted by the first model. On the premise that the model's original generation capability is maintained as much as possible, it is conducive to enabling the model to learn the content that the model cannot generate, such as the content that does not meet the preset constraint, so as to enable the model to forget the data that does not meet the preset constraint on the premise that the model's original generation capability is maintained as much as possible. Therefore, the model has both an image generation capability and a certain feature screening capability, which can effectively ensure that subsequent images generated by using the model all meet the preset constraint, thereby effectively avoiding defects caused by the generation of images that do not meet the preset constraint, and then improving the image generation effect.

In practice, in some scenarios, in order to better improve the model performance, optimization processing may be performed through a multi-round iterative method. Based on it, the present disclosure further provides an optimization solution, which may specifically include the following steps 21 to 23.

Step 21: acquiring sample text, a noisy image corresponding to the sample text, and a first noise distribution corresponding to the sample text, where the noisy image is obtained by adding noise to a sample image corresponding to the sample text according to a target noise distribution, the sample image does not meet a preset constraint, and the first noise distribution is predicted by a first model based on the sample text.

It should be noted that for the relevant content of the step 21, reference is made to the relevant content of S201 above.

Step 22: using a second model to process the sample text and the noisy image to obtain a second noise distribution, where an initial value of the second model is determined based on the first model.

It should be noted that for the relevant content of the step 22, reference is made to the relevant content of S202 above.

Step 23: updating the second model based on the second noise distribution, the first noise distribution and the target noise distribution, and returning to continue performing the above step 21 and subsequent steps until a preset stop condition is satisfied.

The preset stop condition is a preset condition that needs to be satisfied when a multi-round iterative process ends.

In addition, an implementation of the preset stop condition is not limited in the present disclosure. For example, the preset stop condition may include: the model loss of the second model being lower than a preset threshold. For another example, the preset stop condition may include: a change rate of the model loss of the second model being lower than a preset change rate. For another example, the preset stop condition may include: the quantity of updating the second model reaching a preset quantity threshold.

Based on the relevant content of the above steps 21 to 23, it can be learned that in some scenarios, for the first model with a good performance in text-to-image generation, the present disclosure can implement the optimization for the first model through the multi-round iterative method, such that the finally obtained model can learn the content that the model cannot generate, such as the content that does not meet the preset constraint, on the premise that the original generation capability is maintained as much as possible. Thus, the model is caused to forget the data that does not meet the preset constraint on the premise that the original generation capability is maintained as much as possible. Therefore, the model has both an image generation capability and a certain feature screening capability, which can effectively ensure that subsequent images generated by using the model all meet the preset constraint, thereby effectively avoiding defects caused by the generation of images that do not meet the preset constraint, and then improving the image generation effect.

In addition, the present disclosure further provides an image generation method. As shown in FIG. 3, the image generation method includes S301 and S302 below. FIG. 3 is a flowchart of an image generation method according to an embodiment of the present disclosure.

S301: acquiring text to be processed.

The text to be processed is text that needs to be used during image generation, such as text that is input by a user.

In addition, the method for acquiring the text to be processed is not limited in the present disclosure. For example, the text to be processed may be text input by the user using a certain method.

S302: using a diffusion model to process the text to be processed to obtain a generated image, where the diffusion model is obtained by using any one of the implementations of the model update method according to the present disclosure, and the generated image meets the preset constraint.

The diffusion model is a model that is obtained by performing at least one round of optimization on the first model, such that the diffusion model not only has a better image generation performance, but also learns the content that it cannot generate. Therefore, the diffusion model has both an image generation capability and a certain feature screening capability, which can ensure that an image output by the diffusion model meets the preset constraint.

Based on the relevant content of S301 and S302 above, it can be learned that for the image generation method according to the present disclosure, after the text to be processed is obtained, the optimized diffusion model is used to process the text to be processed, so as to obtain the generated image. Since the diffusion model is obtained by using the optimization solution according to the present disclosure, the diffusion model not only has a better image generation performance, but also learns the content that it cannot generate, such as the content that does not meet the preset constraint. Therefore, the diffusion model has both an image generation capability and a certain feature screening capability, which can ensure that the image output by the diffusion model, such as the generated image, meets the preset constraint, so as to effectively overcome defects caused by the generated image not meeting the preset constraint, and then improve the image generation effect.

In addition, the execution body of the image generation method according to the embodiments of the present disclosure is not limited in the present disclosure. For example, the image generation method according to the embodiments of the present disclosure may be applied to a terminal device or a server. For another example, the image generation method according to the embodiments of the present disclosure may also be implemented with the aid of a data interaction process between the terminal device and the server.

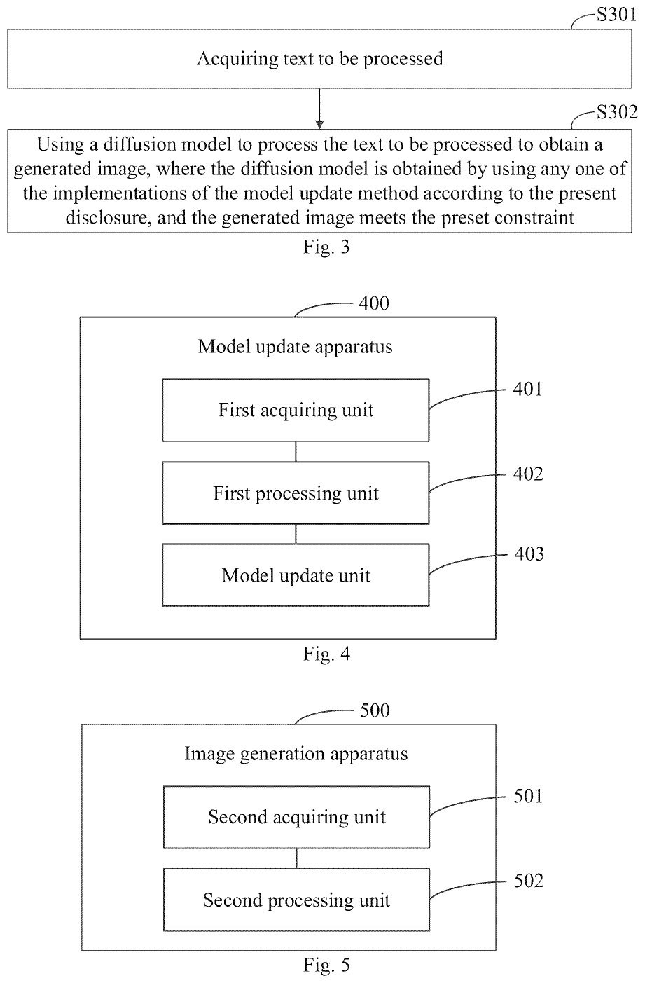

Based on the model update method according to the embodiments of the present disclosure, an embodiment of the present disclosure further provides a model update apparatus, which is explained and illustrated in conjunction with FIG. 4 below. FIG. 4 is a structural schematic diagram of a model update apparatus according to an embodiment of the present disclosure. It should be noted that for technical details of the model update apparatus according to the embodiment of the present disclosure, reference is made to the relevant content of the above model update method.

As shown in FIG. 4, the model update apparatus 400 according to the embodiment of the present disclosure includes a first acquiring unit 401, a first processing unit 402 and a model update unit 403.

The first acquiring unit 401 is configured to acquire sample text, a noisy image corresponding to the sample text, and a first noise distribution corresponding to the sample text, where the noisy image is obtained by adding noise to a sample image corresponding to the sample text according to a target noise distribution, the sample image does not meet a preset constraint, and the first noise distribution is predicted by a first model based on the sample text.

The first processing unit 402 is configured to use a second model to process the sample text and the noisy image to obtain a second noise distribution, where an initial value of the second model is determined based on the first model.

The model update unit 403 is configured to update the second model based on the second noise distribution, the first noise distribution, and the target noise distribution, to obtain an updated second model, where a difference between the target noise distribution and a third noise distribution predicted by the updated second model based on the sample text is greater than a difference between the second noise distribution and the target noise distribution, and a difference between the third noise distribution and the first noise distribution does not exceed a difference between the target noise distribution and the first noise distribution.

In a possible implementation, the model update unit 403 is specifically configured to:

calculate the difference between the first noise distribution and the target noise distribution to obtain a first difference, and calculate the difference between the second noise distribution and the target noise distribution to obtain a second difference;

determine a model loss of the second model based on the first difference, a weight corresponding to the first difference, the second difference, and a weight corresponding to the second difference, where the weight corresponding to the first difference is a positive number, and the weight corresponding to the second difference is a negative number; and update the second model based on the model loss.

In a possible implementation, the first model is obtained by using an image that meets the preset constraint and text corresponding to the image that meets the preset constraint to perform model training.

In a possible implementation, the target noise distribution includes a noise ground-truth corresponding to each timestep in a timestep sequence; the first noise distribution includes a first noise prediction value corresponding to each timestep in the timestep sequence; and the second noise distribution includes a second noise prediction value corresponding to each timestep in the timestep sequence.

Based on the relevant content of the above model update apparatus 400, the working principle of the model update apparatus 400 according to the present disclosure is as follows. For the first model with a good performance in text-to-image generation, the optimization process for the first model includes: first, acquiring sample text, a noisy image corresponding to the sample text, and a first noise distribution corresponding to the sample text, where the noisy image is obtained by adding noise to a sample image corresponding to the sample text according to a target noise distribution, the sample image does not meet a preset constraint, and the first noise distribution is predicted by a first model based on the sample text; next, using a second model to process the sample text and the noisy image to obtain a second noise distribution, where an initial value of the second model is determined based on the first model; and then, updating the second model based on the second noise distribution, the first noise distribution and the target noise distribution to obtain an updated second model that meets the following constraint, in which a difference between the target noise distribution and a third noise distribution predicted by the updated second model based on the sample text is greater than a difference between the second noise distribution and the target noise distribution, and a difference between the third noise distribution and the first noise distribution does not exceed a difference between the target noise distribution and the first noise distribution, such that the noise distribution predicted by the updated second model is as far as possible from the noise distribution predicted by the second model before the update, and the noise distribution predicted by the updated second model is as close as possible to the noise distribution predicted by the first model. On the premise that the model's original generation capability is maintained as much as possible, it is conducive to enabling the model to learn the content that the model cannot generate, such as the content that does not meet the preset constraint, so as to enable the model to forget the data that does not meet the preset constraint on the premise that the model's original generation capability is maintained as much as possible.

Therefore, the model has both an image generation capability and a certain feature screening capability, which can effectively ensure that subsequent images generated by using the model all meet the preset constraint, thereby effectively avoiding defects caused by the generation of images that do not meet the preset constraint, and then improving the image generation effect.

Based on the image generation method according to the embodiments of the present disclosure, an embodiment of the present disclosure further provides an image generation apparatus, which is explained and illustrated in conjunction with FIG. 5 below. FIG. 5 is a structural schematic diagram of an image generation apparatus according to an embodiment of the present disclosure. It should be noted that for technical details of the image generation apparatus according to the embodiment of the present disclosure, reference is made to the relevant content of the above image generation method.

As shown in FIG. 5, the image generation apparatus 500 according to the embodiment of the present disclosure includes a second acquiring unit 501 and a second processing unit 502.

The second acquiring unit 501 is configured to acquire text to be processed.

The second processing unit 502 is configured to use a diffusion model to process the text to be processed to obtain a generated image, where the diffusion model is obtained using any one of the implementations of the model update method according to the present disclosure, and the generated image meets the preset constraint.

Based on the relevant content of the above image generation apparatus 500, the working principle of the image generation apparatus 500 according to the present disclosure is as follows. After the text to be processed is acquired, the text to be processed is processed by using the optimized diffusion model, so as to obtain the generated image. Since the diffusion model is obtained by using the optimization solution according to the present disclosure, the diffusion model not only has a good image generation performance, but also learns the content that the diffusion model cannot generate, such as the content that does not meet the preset constraint, which can ensure that the image output by the diffusion model, such as the generated image, meets the preset constraint, so as to effectively overcome defects caused by the generated image not meeting the preset constraint, and then improve the image generation effect.

In addition, an embodiment of the present disclosure further provides an electronic device. The electronic device includes a processor and a memory. The memory is configured to store instructions or a computer program; and the processor is configured to execute the instructions or the computer program in the memory to cause the electronic device to perform any one of the implementations of the model update method or the image generation method according to the embodiments of the present disclosure.

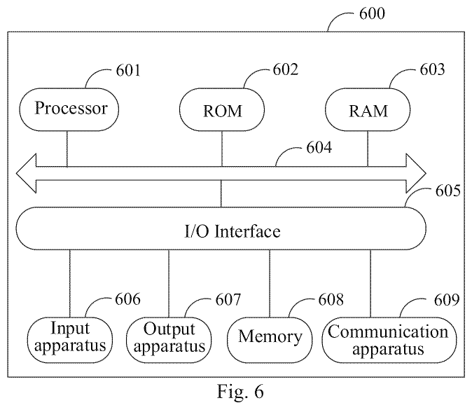

Reference is made to FIG. 6, which is a structural schematic diagram of an electronic device 600 suitable for implementing an embodiment of the present disclosure. A terminal device in this embodiment of the present disclosure may include, but is not limited to, mobile terminals such as a mobile phone, a notebook computer, a digital broadcast receiver, a personal digital assistant (PDA), a tablet computer (portable Android device, PAD), a portable media player (PMP), and a vehicle-mounted terminal (e.g., a vehicle navigation terminal), and fixed terminals such as a digital TV and a desktop computer. The electronic device shown in FIG. 6 is merely an example, and shall not impose any limitation on the function and scope of use of the embodiments of the present disclosure.

As shown in FIG. 6, the electronic device 600 may include a processor (e.g., a central processing unit, a graphics processor, etc.) 601 that may perform a variety of appropriate actions and processing in accordance with a program stored in a read-only memory (ROM) 602 or a program loaded from a memory 608 into a random access memory (RAM) 603. The RAM 603 further stores various programs and data required for operations of the electronic device 600. The processor 601, the ROM 602, and the RAM 603 are connected to one another through a bus 604. An input/output (I/O) interface 605 is also connected to the bus 604.

Generally, the following apparatuses may be connected to the I/O interface 605: an input apparatus 606 including, for example, a touchscreen, a touchpad, a keyboard, a mouse, a camera, a microphone, an accelerometer, and a gyroscope; an output apparatus 607 including, for example, a liquid crystal display (LCD), a speaker, and a vibrator; the memory 608 including, for example, a tape and a hard disk; and a communication apparatus 609. The communication apparatus 609 may allow the electronic device 600 to perform wireless or wired communication with other devices to exchange data. Although FIG. 6 shows the electronic device 600 having various apparatuses, it should be understood that it is not required to implement or have all of the shown apparatuses. It may be an alternative to implement or have more or fewer apparatuses.

In particular, according to an embodiment of the present disclosure, the process described above with reference to the flowchart may be implemented as a computer software program. For example, an embodiment of the present disclosure includes a computer program product, which includes a computer program carried on a non-transitory computer-readable medium, where the computer program includes program code for performing the method shown in the flowchart. In such an embodiment, the computer program may be downloaded and installed from a network through the communication apparatus 609, installed from the memory 608, or installed from the ROM 602. When the computer program is executed by the processor 601, the above functions defined in the method of the embodiment of the present disclosure are performed.

The electronic device according to this embodiment of the present disclosure and the method according to the above embodiments belong to the same inventive concept. For the technical details not exhaustively described in this embodiment, reference may be made to the above embodiments, and this embodiment and the above embodiments have the same beneficial effects.

An embodiment of the present disclosure further provides a computer-readable medium, and the computer-readable medium stores instructions or a computer program that. When the instructions or the computer program is run on a device, the device is caused to perform any one of the implementations of the model update method or image generation method according to the embodiments of the present disclosure.

It should be noted that the above computer-readable medium described in the present disclosure may be a computer-readable signal medium, a computer-readable storage medium, or any combination thereof. The computer-readable storage medium may be, for example but not limited to, electric, magnetic, optical, electromagnetic, infrared, or semiconductor systems, apparatuses, or devices, or any combination thereof. More specific examples of the computer-readable storage medium may include, but are not limited to: an electrical connection having one or more wires, a portable computer magnetic disk, a hard disk, a random access memory (RAM), a read-only memory (ROM), an erasable programmable read-only memory (EPROM) (or a flash memory), an optical fiber, a portable compact disc read-only memory (CD-ROM), an optical storage device, a magnetic storage device, or any suitable combination thereof. In the present disclosure, the computer-readable storage medium may be any tangible medium containing or storing a program which may be used by or in combination with an instruction execution system, apparatus, or device. In the present disclosure, the computer-readable signal medium may include a data signal propagated in a baseband or as a part of a carrier, the data signal carrying computer-readable program code. The propagated data signal may be in various forms, including but not limited to an electromagnetic signal, an optical signal, or any suitable combination thereof. The computer-readable signal medium may further be any computer-readable medium other than the computer-readable storage medium. The computer-readable signal medium may send, propagate, or transmit a program used by or in combination with the instruction execution system, apparatus, or device. The program code contained in the computer-readable medium may be transmitted by any suitable medium, including but not limited to: electric wires, optical cables, radio frequency (RF), etc., or any suitable combination thereof.

In some implementations, a client and a server may perform communication by using any currently known or future-developed network protocol such as a hypertext transfer protocol (HTTP), and may interconnect with digital data communication (e.g., a communication network) in any form or medium. Examples of the communication network include a local area network (“LAN”), a wide area network (“WAN”), an internetwork (e.g., the Internet), a peer-to-peer network (e.g., an ad hoc peer-to-peer network), and any currently known or future-developed network.

The above computer-readable medium may be contained in the above electronic device, or may exist independently, without being assembled into the electronic device.

The above computer-readable medium carries one or more programs that, when executed by the electronic device, enable the electronic device to perform the above method.

Computer program code for performing operations of the present disclosure may be written in one or more programming languages or a combination thereof, where the above programming languages include, but are not limited to, object-oriented programming languages, such as Java, Smalltalk, and C++, and further include conventional procedural programming languages, such as “C” language or similar programming languages. The program code may be completely executed on a user computer, partially executed on the user computer, executed as a stand-alone software package, partially executed on the user computer and partially executed on a remote computer, or completely executed on the remote computer or the server. In the case of the remote computer, the remote computer may be connected to the user computer through any kind of network, including a local area network (LAN) or a wide area network (WAN), or may be connected to an external computer (e.g., connected through the Internet with the aid of an Internet service provider).

The flowchart and the block diagram in the drawings illustrate the possibly implemented architecture, functions, and operations of the system, the method, and the computer program product according to various embodiments of the present disclosure. In this regard, each block in the flowchart or the block diagram may represent a module, a program segment, or a part of code, and the module, the program segment, or the part of code contains one or more executable instructions for implementing specified logical functions. It should also be noted that, in some alternative implementations, the functions marked in the blocks may also occur in an order different from that marked in the drawings. For example, two blocks shown in succession may actually be performed substantially in parallel, or may sometimes be performed in a reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The related units described in the embodiments of the present disclosure may be implemented by software, or may be implemented by hardware. The name of the unit/module does not constitute a limitation on the unit itself under certain circumstances.

Herein, the functions described above may be performed at least partially by one or more hardware logic components. For example, without limitation, exemplary types of hardware logic components that may be used include: a field programmable gate array (FPGA), an application-specific integrated circuit (ASIC), an application-specific standard product (ASSP), a system-on-chip (SOC), a complex programmable logic device (CPLD), etc.

In the context of the present disclosure, a machine-readable medium may be a tangible medium that may contain or store a program used by or in combination with the instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the above content. More specific examples of the machine-readable storage medium may include an electrical connection based on one or more wires, a portable computer disk, a hard disk, a random access memory (RAM), a read-only memory (ROM), an erasable programmable read-only memory (EPROM) (or a flash memory), an optical fiber, a portable compact disc read-only memory (CD-ROM), an optical storage device, a magnetic storage device, or any suitable combination of the above content.

It should be noted that the various embodiments in this specification are described in a progressive manner, and each embodiment focuses on the differences from other embodiments. The same or similar parts between the various embodiments may be referenced to each other. For the system or apparatus disclosed in this embodiment, since it corresponds to the method disclosed in the embodiments, the description is relatively simple, and for the related parts, reference may be made to the description of the method.

It should be understood that, in the present disclosure, “at least one” means one or more, and “a plurality of” means two or more. The term “and/or” is used to describe an association relationship between associated objects, and indicates that three relationships may exist, for example, A and/or B may indicate that: only A exists, only B exists, and both A and B exist, where A or B may be singular or plural. The character “/” generally indicates an “or” relationship between the preceding and succeeding associated objects. “At least one of the following items” or similar expressions refer to any combination of these items, including any combination of single or plural items. For example, at least one of a, b, or c may indicate: a, b, and c, “a and b”, “a and c”, “b and c”, or “a, b, and c”, where a, b, or c may be singular or plural.

It should also be noted that herein, relational terms such as “first” and “second” are only used to distinguish one entity or operation from another entity or operation, and do not necessarily require or imply that such an actual relationship or order exists between these entities or operations. Moreover, the terms “include”, “contain”, or any of their variants is intended to cover a non-exclusive inclusion, such that a process, a method, an article, or a device that includes a list of elements not only includes those elements but also includes other elements that are not expressly listed, or further includes elements inherent to such process, method, article, or device. In the absence of more restrictions, an element defined by the phrase “including a . . . ” does not exclude another identical element in the process, the method, the article, or the device that includes the element.

The steps of the method or the algorithm described in conjunction with the embodiments disclosed herein may be implemented directly in hardware, in a software module executed by a processor, or in a combination of the two. The software module may be disposed in a random access memory (RAM), an internal memory, a read-only memory (ROM), an electrically programmable ROM, an electrically erasable programmable ROM, a register, a hard disk, a removable disk, a CD-ROM, or any other form of storage medium known in the art.

With respect to the above description of the disclosed embodiments, those skilled in the art could implement or use the present disclosure. Various modifications to these embodiments are apparent to those skilled in the art, and the general principle defined herein may be implemented in other embodiments without departing from the spirit or scope of the present disclosure. Therefore, the present disclosure is not limited to the embodiments described herein but is to be accorded with the broadest scope consistent with the principle and novel features disclosed herein.

1. A model update method, comprising:
acquiring sample text, a noisy image corresponding to the sample text, and a first noise distribution corresponding to the sample text, wherein the noisy image is obtained by adding noise to a sample image corresponding to the sample text according to a target noise distribution, the sample image does not meet a preset constraint, and the first noise distribution is predicted by a first model based on the sample text;
using a second model to process the sample text and the noisy image to obtain a second noise distribution, wherein an initial value of the second model is determined based on the first model; and
updating the second model based on the second noise distribution, the first noise distribution and the target noise distribution, to obtain an updated second model, wherein a difference between the target noise distribution and a third noise distribution predicted by the updated second model based on the sample text is greater than a difference between the second noise distribution and the target noise distribution; and a difference between the third noise distribution and the first noise distribution does not exceed a difference between the target noise distribution and the first noise distribution.

2. The model update method according to claim 1, wherein the updating the second model based on the second noise distribution, the first noise distribution and the target noise distribution, comprises:
calculating the difference between the first noise distribution and the target noise distribution to obtain a first difference, and calculating the difference between the second noise distribution and the target noise distribution to obtain a second difference;
determining a model loss of the second model based on the first difference, a weight corresponding to the first difference, the second difference and a weight corresponding to the second difference, wherein the weight corresponding to the first difference is a positive number, and the weight corresponding to the second difference is a negative number; and
updating the second model based on the model loss.

3. The model update method according to claim 1, wherein the first model is obtained by using an image that meets the preset constraint and text corresponding to the image that meets the preset constraint to perform model training.

4. The model update method according to claim 1, wherein the target noise distribution comprises a noise ground-truth corresponding to each timestep in a timestep sequence;
the first noise distribution comprises a first noise prediction value corresponding to each timestep in the timestep sequence; and
the second noise distribution comprises a second noise prediction value corresponding to each timestep in the timestep sequence.

5. The model update method according to claim 2, wherein the first model is obtained by using an image that meets the preset constraint and text corresponding to the image that meets the preset constraint to perform model training.

6. The model update method according to claim 2, wherein the target noise distribution comprises a noise ground-truth corresponding to each timestep in a timestep sequence;
the first noise distribution comprises a first noise prediction value corresponding to each timestep in the timestep sequence; and
the second noise distribution comprises a second noise prediction value corresponding to each timestep in the timestep sequence.

7. The model update method according to claim 3, wherein the target noise distribution comprises a noise ground-truth corresponding to each timestep in a timestep sequence;
the first noise distribution comprises a first noise prediction value corresponding to each timestep in the timestep sequence; and
the second noise distribution comprises a second noise prediction value corresponding to each timestep in the timestep sequence.

8. An image generation method, comprising:
acquiring text to be processed; and
using a diffusion model to process the text to be processed to obtain a generated image, wherein the diffusion model is obtained by using a model update method, the generated image meets a preset constraint, and the model update method comprises:
acquiring sample text, a noisy image corresponding to the sample text, and a first noise distribution corresponding to the sample text, wherein the noisy image is obtained by adding noise to a sample image corresponding to the sample text according to a target noise distribution, the sample image does not meet the preset constraint, and the first noise distribution is predicted by a first model based on the sample text;
using a second model to process the sample text and the noisy image to obtain a second noise distribution, wherein an initial value of the second model is determined based on the first model; and
updating the second model based on the second noise distribution, the first noise distribution and the target noise distribution, to obtain an updated second model, wherein a difference between the target noise distribution and a third noise distribution predicted by the updated second model based on the sample text is greater than a difference between the second noise distribution and the target noise distribution; and a difference between the third noise distribution and the first noise distribution does not exceed a difference between the target noise distribution and the first noise distribution.

9. The image generation method according to claim 8, wherein the updating the second model based on the second noise distribution, the first noise distribution and the target noise distribution, comprises:
calculating the difference between the first noise distribution and the target noise distribution to obtain a first difference, and calculating the difference between the second noise distribution and the target noise distribution to obtain a second difference;
determining a model loss of the second model based on the first difference, a weight corresponding to the first difference, the second difference and a weight corresponding to the second difference, wherein the weight corresponding to the first difference is a positive number, and the weight corresponding to the second difference is a negative number; and
updating the second model based on the model loss.

10. The image generation method according to claim 8, wherein the first model is obtained by using an image that meets the preset constraint and text corresponding to the image that meets the preset constraint to perform model training.

11. The image generation method according to claim 8, wherein the target noise distribution comprises a noise ground-truth corresponding to each timestep in a timestep sequence;
the first noise distribution comprises a first noise prediction value corresponding to each timestep in the timestep sequence; and
the second noise distribution comprises a second noise prediction value corresponding to each timestep in the timestep sequence.

12. An electronic device, comprising: a processor and a memory,
wherein the memory is configured to store instructions or a computer program; and
the processor is configured to execute the instructions or the computer program stored in the memory, to cause the electronic device to perform a model update method or an image generation method;
the model update method comprises:
acquiring sample text, a noisy image corresponding to the sample text, and a first noise distribution corresponding to the sample text, wherein the noisy image is obtained by adding noise to a sample image corresponding to the sample text according to a target noise distribution, the sample image does not meet a preset constraint, and the first noise distribution is predicted by a first model based on the sample text;
using a second model to process the sample text and the noisy image to obtain a second noise distribution, wherein an initial value of the second model is determined based on the first model; and
updating the second model based on the second noise distribution, the first noise distribution and the target noise distribution, to obtain an updated second model, wherein a difference between the target noise distribution and a third noise distribution predicted by the updated second model based on the sample text is greater than a difference between the second noise distribution and the target noise distribution; and a difference between the third noise distribution and the first noise distribution does not exceed a difference between the target noise distribution and the first noise distribution;
the image generation method comprises:
acquiring text to be processed; and
using a diffusion model to process the text to be processed to obtain a generated image, wherein the diffusion model is obtained by using the model update method, the generated image meets the preset constraint.

13. The electronic device according to claim 12, wherein the updating the second model based on the second noise distribution, the first noise distribution and the target noise distribution, comprises:
calculating the difference between the first noise distribution and the target noise distribution to obtain a first difference, and calculating the difference between the second noise distribution and the target noise distribution to obtain a second difference;
determining a model loss of the second model based on the first difference, a weight corresponding to the first difference, the second difference and a weight corresponding to the second difference, wherein the weight corresponding to the first difference is a positive number, and the weight corresponding to the second difference is a negative number; and
updating the second model based on the model loss.

14. The electronic device according to claim 12, wherein the first model is obtained by using an image that meets the preset constraint and text corresponding to the image that meets the preset constraint to perform model training.

15. The electronic device according to claim 12, wherein the target noise distribution comprises a noise ground-truth corresponding to each timestep in a timestep sequence;
the first noise distribution comprises a first noise prediction value corresponding to each timestep in the timestep sequence; and
the second noise distribution comprises a second noise prediction value corresponding to each timestep in the timestep sequence.

16. A non-transitory computer-readable medium, wherein the non-transitory computer-readable medium stores instructions or a computer program, and when the instructions or the computer program is run on a device, the device is caused to perform the model update method according to claim 1.

17. The non-transitory computer-readable medium according to claim 16, wherein the updating the second model based on the second noise distribution, the first noise distribution and the target noise distribution, comprises:
calculating the difference between the first noise distribution and the target noise distribution to obtain a first difference, and calculating the difference between the second noise distribution and the target noise distribution to obtain a second difference;
determining a model loss of the second model based on the first difference, a weight corresponding to the first difference, the second difference and a weight corresponding to the second difference, wherein the weight corresponding to the first difference is a positive number, and the weight corresponding to the second difference is a negative number; and
updating the second model based on the model loss.

18. The non-transitory computer-readable medium according to claim 16, wherein the first model is obtained by using an image that meets the preset constraint and text corresponding to the image that meets the preset constraint to perform model training.

19. The non-transitory computer-readable medium according to claim 16, wherein the target noise distribution comprises a noise ground-truth corresponding to each timestep in a timestep sequence;
the first noise distribution comprises a first noise prediction value corresponding to each timestep in the timestep sequence; and
the second noise distribution comprises a second noise prediction value corresponding to each timestep in the timestep sequence.

20. A non-transitory computer-readable medium, wherein the non-transitory computer-readable medium stores instructions or a computer program, and when the instructions or the computer program is run on a device, the device is caused to perform the image generation method according to claim 8.
